(19) United States
(12) Patent Application Publication
(10) Pub. No.: US 2015/0217374 A1
(43) Pub. Date: Aug. 6, 2015

(54) METHOD FOR MANUFACTURING METAL NANOPARTICLES BY USING PHASE TRANSITION REDUCTION, AND METAL INK COMPRISING METAL NANOPARTICLES MANUFACTURED THEREBY

(71) Applicant: SAMSUNG FINE CHEMICALS CO., LTD, Ulsan (KR)

(72) Inventors: Sung Soon Kim, Gyeonggi-do (KR); Eui Hyun Ryu, Daejeon (KR); Chan Hyuk Park, Seoul (KR); Mi Young Kim, Seoul (KR); Kyung Yol Yon, Gyeonggi-do (KR)

(73) Assignee: SAMSUNG FINE CHEMICALS CO., LTD, Ulsan (KR)

(21) Appl. No.: 14/422,425

(22) PCT Filed: May 9, 2013
(86) PCT No.: PCT/KR2013/004108

§ 371 Date: Feb. 19, 2015

(30) Foreign Application Priority Data
Aug. 23, 2012 (KR) 10-2012-0092106

(51) Int. Cl. B22F 9/24; C22C 5/06; C22B 3/00; H01B 1/02

(52) U.S. Cl. CPC B22F 9/24; H01B 1/02; C22C 5/06; C22B 11/04

(57) ABSTRACT

A method of preparing metal nanoparticles using a phase transfer reduction method in which a reduction reaction is adjusted by distribution equilibrium between an intermediate formed by a coordinate bond between a capping material and various metal precursors in the form of an organic phase and a reducing agent present in an aqueous phase, and a metal ink prepared from the metal nanoparticles. The method of preparing metal nanoparticles includes dissolving a metal precursor and a capping agent in an organic phase, dissolving a reducing agent in an aqueous phase, mixing the organic phase and the aqueous phase to form a precipitate, separating the precipitate, and drying the separated precipitate. The metal nanoparticles prepared using the method can be prepared to have various particle sizes according to the kind of precursors and a length of an alkyl chain of an amine used as the capping agent. As a self-quenching reaction in which growth of the nanoparticles in the aqueous layer is stopped takes place since the nanoparticle precipitate into the aqueous layer from the organic layer due to a difference in density of the metal nanoparticles formed during a reaction, a particle size of the metal nanoparticles can be easily controlled, and excellent processability in which the metal nanoparticles are easily separated/purified from the organic layer in which most reaction by-products are present can be ensured. Also, as the metal nanoparticles having various particle sizes are able to be prepared, a metal ink having various sintering temperatures spanning from a low temperature to a high temperature can be prepared using the metal nanoparticles.

### TECHNICAL FIELD

The present invention relates to a method of preparing metal nanoparticles using a phase transfer reduction method, and a metal ink including the metal nanoparticles prepared using the same. More particularly, the present invention relates to a method of preparing metal nanoparticles using a phase transfer reduction method in which a reduction reaction is adjusted by distribution equilibrium between an intermediate formed by a coordinate bond between a capping material and various metal precursors in the form of an organic phase and a reducing agent present in an aqueous phase, and a metal ink including the metal nanoparticles prepared using the same.

### BACKGROUND ART

A metal ink has been used for various products such as a conductive ink, an electromagnetic wave shielding agent, a reflective film forming material, an antibacterial agent, etc. In particular, conductive inks are used due to current regulations on use of lead in electric/electronic circuits, used for low-resistivity metal interconnections, printed circuit boards (PCBs), flexible printed circuit boards (FPCBs), antennas for radio frequency identification (RFID) tags and electromagnetic wave shielding materials, and are useful when a metal pattern is required or electrodes are simply formed in the field of new applications such as plasma display panels (PDPs), liquid crystal displays (TFT-LCDs), organic light emitting diodes (OLEDs), flexible displays and organic thin film transistors (OTFTs), and thus attention has been increasingly paid to the conductive inks. With the tendency toward highly functional and very thin electronic products, metal particles used in the electronic products are gradually becoming finer in size.

In general, metal inks have been prepared by producing a metal precursor or metal nanoparticles into ink.

The metal nanoparticles used in the metal ink have been prepared by performing a reduction reaction in a single phase. However, when the reduction reaction is performed in the single phase, it is possible to adjust a particle size of the metal nanoparticles, but it is difficult to accurately adjust reaction conditions, and separation/purification processes are troublesome. Therefore, since many reaction by-products remain in a metal ink, physical properties of the metal ink are affected upon preparation of the metal ink, a manufacturing process is complicated, and the yield is low.

Accordingly, the present inventors have synthesized metal precursors having various structures, and prepared metal nanoparticles through a reduction reaction using phase transfer behavior in which reaction materials are distributed in an organic phase and an aqueous phase by distribution equilibrium between an intermediate formed by a coordinate bond between the prepared metal precursors and a capping material and a reducing agent present in the aqueous phase. In this case, a particle size of the metal nanoparticles can be controlled according to the kind of the metal precursors used herein and the capping material. Also, when a metal ink is prepared using the metal nanoparticles whose particle sizes are controlled as described above, it is possible to adjust a sintering temperature spanning from a low temperature to a high temperature and prepare a metal ink having excellent electrical properties.

### DISCLOSURE

### Technical Problem

The present invention is directed to a method of preparing metal nanoparticles having various particle sizes according to a metal precursor and a capping material. Here, the metal precursor is synthesized to have various structures, and the metal nanoparticles are synthesized through a reduction reaction using phase transfer behavior in which reaction materials are distributed in an organic phase or an aqueous phase according to distribution equilibrium between an intermediate formed by a coordinate bond between the prepared metal precursor and a capping material and a reducing agent present in the aqueous phase.

Also, the present invention is directed to a metal ink having various sintering temperatures and exhibiting improved electrical properties by applying the metal nanoparticles having various particle sizes according to the capping material prepared using the above-described phase transfer reduction method.

### Technical Solution

According to an aspect of the present invention, there is provided a method of preparing metal nanoparticles. Here, the method includes dissolving a metal precursor and a capping agent in an organic phase, dissolving a reducing agent in an aqueous phase, mixing the organic phase and the aqueous phase to form a precipitate, separating the precipitate, and drying the separated precipitate.

The method according to the present invention may further include purifying the separated precipitate.

In the method of preparing metal nanoparticles according to the present invention, the metal precursor may be a metal precursor having a structure represented by the following Formula 1 prepared from various fatty acids.

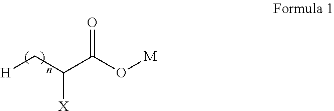

In Formula 1, X represents hydrogen, an alkyl group having 1 to 6 carbon atoms, or a halogen, M is selected from the group consisting of Ag, Pd, Rh, Cu, Pt, Ni, Fe, Ru, Os, Mn, Cr, Mo, Au, W, Co, Ir, Zn and Cd, and n is an integer ranging from 0 to 23.

The capping agent contains an alkyl chain having a length of 4 to 20, and each alkyl chain may be a primary, secondary or tertiary amine. Also, the reducing agent may be at least one selected from the group consisting of trisodium citrate, NaBH₄, phenylhydrazine.HCl, ascorbic acid, phenylhydrazine, and hydrazine.

The mixing of the organic phase and the aqueous phase may be performed by dropping the aqueous phase in the organic phase at a rate of 1 ml/sec to 1,000 ml/h.

The capping agent may be used at a molar concentration 1 to 10 times that of the metal precursor, and the reducing agent may be used at a molar concentration 2 to ¼ times that of the metal precursor.

According to another aspect of the present invention, there is provided a metal ink including the metal nanoparticles prepared using the method. The metal ink includes a dispersion stabilizer, and a solvent which serves as a dispersion medium in which the metal nanoparticles are dispersed. In this case, the metal ink may further include other additives such as a binder to adjust physical properties.

The solvent may be at least one selected from the group consisting of an ether (THF, ethyl ether, propyl ether, or MEK), a benzene (xylene, toluene, ethylbenzene, or benzene), an alcohol (methanol, ethanol, butanol, propanol, ethylene glycol, or propylene glycol), a chloride (methylene chloride, or chloroform), a sulfide (DMSO), a nitride (DMF, DEF, ethylamine, ammonia, ethanol amine, diethanol amine, triethanol amine, or triethylamine), and an alkyl (hexane, pentane, or butane), and a dispersion stabilizer, a binder, and other additives may be known materials used to prepare a metal ink including the metal nanoparticles.

Furthermore, to improve dispersibility of the metal nanoparticles, the method may further include performing supersonic agitation, eddy current agitation, mechanical agitation, or ball or roll mill treatment on the metal ink, and the metal nanoparticles may be included at a content of 10 to 70% by weight, based on the total weight of the metal ink.

### Advantageous Effects

The method of preparing metal nanoparticles according to the present invention can be useful in preparing metal nanoparticles having various particle sizes according to the kind of precursors used and a length of an alkyl chain of an amine used as a capping agent by significantly reducing a reduction reaction rate according to distribution equilibrium between an intermediate formed by a coordinate bond between various precursors and a capping material and a reducing agent present in an aqueous phase, in facilitating separation/purification of the metal nanoparticles from an organic layer in which most reaction by-products are present as the nanoparticle precipitate into the aqueous layer from the organic layer due to a difference in density of the metal nanoparticles formed during a reaction, and in ensuring excellent processability in which a particle size of the metal nanoparticles is easily controlled as a self-quenching reaction in which growth of the metal nanoparticles in the aqueous layer is stopped takes place.

Also, as the metal nanoparticles having various controllable particle sizes are able to be prepared, a metal ink exhibiting excellent electrical properties and having various sintering temperatures spanning from a low temperature to a high temperature can be prepared using the metal nanoparticles.

### DESCRIPTION OF DRAWING

The above and other objects, features and advantages of the present invention will become more apparent to those of ordinary skill in the art by describing in detail exemplary embodiments thereof with reference to the accompanying drawings, in which:

FIG. 1 is a flowchart illustrating processes of a method of preparing metal nanoparticles using a phase transfer reduction method according to one exemplary embodiment of the present invention;

FIG. 2 is a schematic diagram showing a method of preparing metal nanoparticles using a phase transfer reduction method according to one exemplary embodiment of the present invention; and

FIG. 3 is a transmission electron microscope (TEM) image showing average particle sizes of the metal nanoparticles which are controlled according to carbon atoms of a capping agent according to one exemplary embodiment of the present invention.

### BEST MODE

Exemplary embodiments of the present invention will be described in detail below with reference to the accompanying drawings. While the present invention is shown and described in connection with exemplary embodiments thereof, it will be apparent to those skilled in the art that various modifications can be made without departing from the scope of the invention.

The present invention provides a method of preparing metal nanoparticles, which includes dissolving a metal precursor and a capping agent in an organic phase, dissolving a reducing agent in an aqueous phase, mixing the organic phase and the aqueous phase to form a precipitate, separating the precipitate, and drying the separated precipitate.

Also, the present invention provides a metal ink including the metal nanoparticles prepared using the above-described method.

Hereinafter, the present invention will be described in further detail with reference to the accompanying drawings.

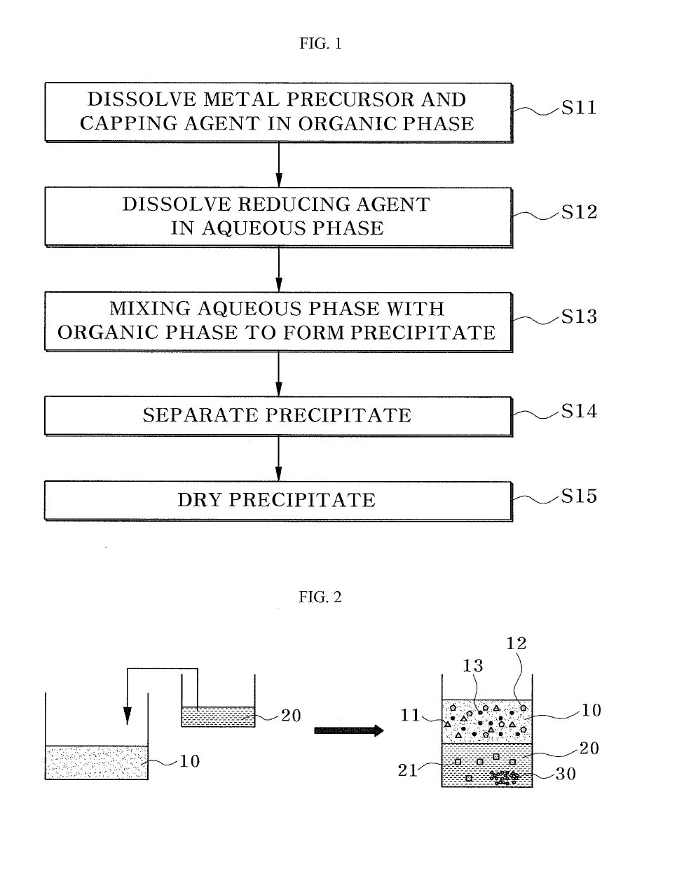

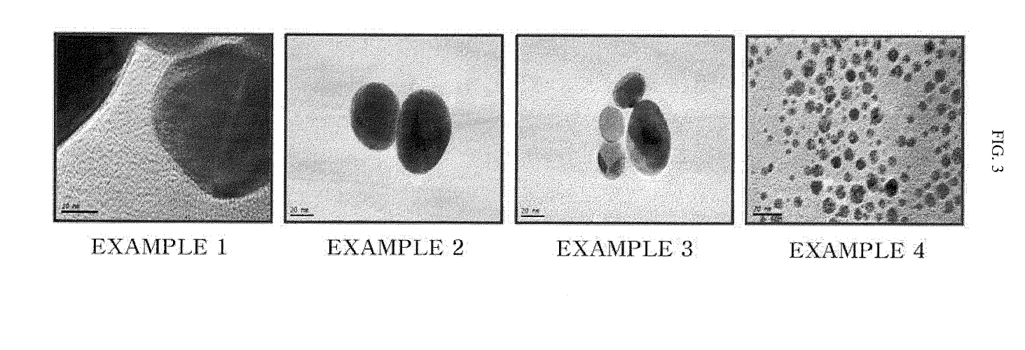

FIG. 1 is a flowchart illustrating processes of a method of preparing metal nanoparticles according to one exemplary embodiment of the present invention, and FIG. 2 is a schematic diagram showing a method of preparing metal nanoparticles according to one exemplary embodiment of the present invention.

Referring to FIG. 1, the method of preparing metal nanoparticles using a phase transfer reduction method according to the present invention includes dissolving a metal precursor and a capping agent in an organic phase (S11), dissolving a reducing agent in an aqueous phase (S12), mixing the organic phase with the aqueous phase to form a precipitate (S13), separating the precipitate (S14), and drying the separated precipitate (S15).

In the dissolving of the metal precursor and the capping agent in the organic phase (S11), a metal precursor prepared from a fatty acid may be used as the metal precursor.

Synthesis of the metal precursor prepared from the fatty acid according to the present invention is performed according to the following Scheme 1.

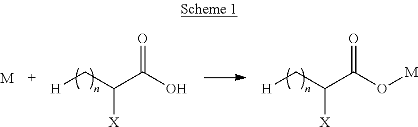

In Scheme 1, X represents hydrogen, an alkyl group having 1 to 6 carbon atoms, or a halogen, M is selected from the group consisting of Ag, Pd, Rh, Cu, Pt, Ni, Fe, Ru, Os, Mn, Cr, Mo, Au, W, Co, Ir, Zn and Cd, and n is an integer ranging from 0 to 23.

Referring to Scheme 1, the synthesis of the metal precursor according to the present invention is performed by allowing a metal to react with a fatty acid in the presence of an organic solvent and a base to synthesize a metal precursor.

More particularly, in the present invention, the formation of the metal precursor includes preparing a fatty acid solution by dissolving a fatty acid in an organic solvent and adding a base, dropping a metal salt solution in the fatty acid solution to allow the metal salt solution to react with the fatty acid solution, and forming a metal precursor precipitate from the mixed solution.

In the preparation of the fatty acid solution by dissolving the fatty acid in the organic solvent, the fatty acid may, for example, include at least one fatty acid selected from the group consisting of hexanoic acid, heptanoic acid, octanoic acid, nonanoic acid, decanoic acid, undecanoic acid, dodecanoic acid, tetradecanoic acid, eicosanoic acid, docosanoic acid, 2-ethylhexanoic acid, 2-methyl hexanoic acid, 2-ethylheptanoic acid, 2-ethylhexanoic acid, oleic acid, linoleic acid, and linolenic acid.

Also, the organic solvent may be at least one selected from the group consisting of H₂O, CH₃CN, CH₃OH, CH₃CH₂OH, THF, DMSO, DMF, 1-methoxy-2-propanol, 2,2-dimethoxy propane, 4-methyl-2-pentanone, and dibutyl ether.

The base may be at least one selected from the group consisting of KOH, NaOH, NH₃, NH₂CH₃, NH₄OH, NH(CH₃)₂, N(CH₃)₃, NH₂Et, NH(Et)₂, NEt₃, and Ca(OH)₂.

In the dropping of the metal salt solution in the fatty acid solution to allow the metal salt solution to react with the fatty acid solution, first, the metal salt solution is prepared by dissolving a metal salt in an organic solvent. Here, CH₃CN, CH₃OH, CH₃CH₂OH, THF, DMSO, DMF, 1-methoxy-2-propanol, 2,2-dimethoxy propane, 4-methyl-2-pentanone, dibutyl ether, or water may be used as the solvent used to dissolve the metal salt.

Next, the metal salt solution is dropped in the fatty acid solution so as to react with the fatty acid solution. In this case, intense agitation may simultaneously accompany the dropping.

Metal ions of the metal salt may be selected from the group consisting of Ag, Pd, Rh, Cu, Pt, Ni, Fe, Ru, Os, Mn, Cr, Mo, Au, W, Co, Ir, Zn and Cd, and may be selected according to a purpose and use. Among the metal ions, a noble metal such as Ag or Au, or Cu may be selected, and Ag is most preferred. All of a nitride, an oxide, a sulfide and a halide may be used as an anionic material of the metal salt. Among these, the anionic material of the metal salt is preferably in the form of a nitride.

The metal salt solution may be dropped in the fatty acid solution at a rate of 50 to 1,000 ml/hr, and the fatty acid solution and the metal salt solution may be mixed at a weight ratio of 1:1 to 5:1. The reaction may be performed at room temperature.

In the formation of the metal precursor precipitate from the mixed solution, the mixed solution in which dropping of the metal salt solution is completed may be further stirred for 1 to 30 minutes to form a precipitate.

In the separation of the precipitate, the precipitate may be removed using conventional separation methods known in the related art. More particularly, a method such as filtration or recrystallization may be used herein.

Subsequently, the separated precipitate may be washed several times with an organic solvent, and then dried to form a metal precursor having a final structure represented by the following Formula 1.

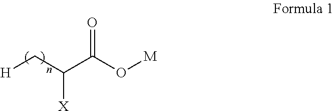

In Formula 1, X represents hydrogen, an alkyl group having 1 to 6 carbon atoms, or a halogen, M is selected from the group consisting of Ag, Pd, Rh, Cu, Pt, Ni, Fe, Ru, Os, Mn, Cr, Mo, Au, W, Co, Ir, Zn and Cd, and n is an integer ranging from 0 to 23.

An alkylamine having a linear or branched structure may be used as the capping material. Here, a size or structure of the alkylamine is not particularly limited. Primary to tertiary amines, that is, monoamines, diamines and triamines, may be used without limitation. In particular, an alkylamine containing a main backbone having 4 to 20 carbon atoms is preferred. In aspects of stability and processability, an alkylamine containing a main backbone having 8 to 18 carbon atoms is more preferred. Also, all degrees of alkylamines are effective as the capping material, but a primary alkylamine may be used in aspects of stability and processability. Meanwhile, an amine substituted with C, H or O at a position of each main alkyl chain may also be used.

More particularly, the capping agent may include primary amines such as butylamine, hexylamine, octylamine, nonylamine, decylamine, dodecylamine, hexadodecylamine, octadecylamine, cocoamine, tallow amine, halogenated tallow amine, oleylamine, laurylamine, and stearylamine, secondary amines such as dicocoamine, dihalogenated tallow amine, and distearylamine, and tertiary amines such as dodecyl dimethylamine, didodecyl monomethylamine, tetradecyl dimethylamine, octadecyl dimethylamine, cocodimethylamine, dodecyl tetradecyl dimethylamine, and trioctylamine. In addition, the capping agent may further include diamines such as naphthalenediamine, stearylpropylenediamine, octamethylenediamine, and nonanediamine. Among these, hexylamine, heptylamine, octylamine, decylamine, dodecylamine, 2-ethylhexylamine, 1,3-dimethyl-n-butylamine, 1-aminoundecane, and 1-aminotridecane are preferred.

The average particle size of the metal nanoparticles is controlled according to the length of the alkyl chain of the amine. For example, when a length of the alkyl chain of the capping agent is 4, the metal nanoparticles have an average particle size of 75 nm, and when the length of the alkyl chain of the capping agent is 8, the metal nanoparticles have an average particle size of 35 nm. Also, when the lengths of the alkyl chain of the capping agent are 10 and 18, the average particle sizes of the metal nanoparticles are controlled to 25 nm and 10 nm, respectively.

In addition to the alkyl chain of the amine, the average particle size of the metal nanoparticles may be controlled according to the kind of a metal precursor as a starting material, a structure of an amine, and a substituent and the number of the substituent.

A non-polar solvent may be used as the organic phase in which the metal precursor and the capping agent are dissolved. More particularly, at least one organic solvent selected from the group consisting of THF, xylene, toluene, methylene chloride, CH₃OH, CH₃CH₂OH, CH₃CH₂CH₂OH and DMSO may be used as the organic phase.

The capping agent may be added at a molar concentration 1 to 10 times that of the metal precursor.

In the dissolving of the reducing agent in the aqueous phase (S12), a reducing agent which can be dissolved in the aqueous phase may be used as the reducing agent. More particularly, at least one selected from the group consisting of trisodium citrate, NaBH₄, phenylhydrazine-HCl and hydrazine may be used as the reducing agent.

The reducing agent dissolved in the aqueous phase may be used at a molar concentration 2 to ¼ times that of the metal precursor. Within a molar concentration range, the reducing agent may be most preferably used at a molar concentration ½ times that of the metal precursor. In this case, when the reducing agent is used at a molar concentration 2 times that of the metal precursor or more, the nanoparticles may overgrow due to an excessive reduction reaction. On the other hand, when the reducing agent is used at a molar concentration ¼ times that of the metal precursor or less, a yield may be significantly lowered due to an increase in an amount of unreacted products.

A polar solvent may be used as the aqueous phase in which the reducing agent is dissolved. More particularly, at least one solvent selected from the group consisting of water, methanol, ethanol and propanol may be used.

Subsequently, in the mixing of the organic phase obtained in Operation (S11) and the aqueous phase obtained in Operation (S12) to form a precipitate (S13), the aqueous phase may be mixed with the organic phase by slowly dropping the aqueous phase in the organic phase.

A dropping rate of the aqueous phase which is dropped in the organic phase may be in a range of 1 ml/sec to 1,000 ml/hr. In this case, when the aqueous phase is dropped at a dropping rate of 1,000 ml/h or less, a process time may be lengthened. On the other hand, when the aqueous phase is dropped at a dropping rate of 1 ml/sec or more, an addition rate may not be easily adjusted, but an effect of the addition rate on the entire growth of the metal nanoparticles is not insignificant.

After the aqueous phase is completely dropped, the mixed solution may be stirred for a predetermined time, for example, 1 to 30 minutes, and a reaction may be stopped to confirm formation of the metal nanoparticles. In this case, the formed metal nanoparticles may be confirmed to be in the form of a precipitate when the metal nanoparticles are kept at room temperature for 60 to 180 minutes or using a centrifuge. In this case, the centrifuge may be used at a rotary speed of 500 to 5,000 rpm for 1 to 30 minutes. Here, the centrifuge is most preferably used at a rotary speed of 1,000 rpm for 5 minutes.

As shown in FIG. 2, the metal precursor and the capping agent are added to an organic phase 10, and the reducing agent is added to an aqueous phase 20. Then, the aqueous phase 20 including the reducing agent is slowly dropped in the organic phase 10. As a result, an unreacted metal precursor 11, a capping agent (amine) 12 and an acid 13 are present in the organic phase 10, and an unreacted reducing agent 21 and a nanoparticle precipitate 30 are formed in the aqueous phase 20.

Even when an amine (M_{W}: 73.14) whose alkyl chain has a length of 4, at which it is impossible to synthesize the metal nanoparticles in a single phase reaction, is used as the capping agent, it is possible to prepare metal nanoparticles having an average particle size of less than 100 nm, and synthesis of the metal nanoparticles is easy regardless of the kind of amines used as the capping agent. Also, a length of the alkyl chain of the amine may be adjusted to control a particle size of the metal nanoparticles.

Then, after the separation of the formed precipitate (S14), the drying of the formed precipitate (S15) may be performed to obtain metal nanoparticles. In this case, the method according to the present invention may further include washing the separated precipitate with an organic solvent before the drying of the formed precipitate.

In this case, the washing may be performed using methanol, ethanol, propanol, acetone, water, ethylene glycol, THF, chloroform, DMSO, etc., and the drying may be performed at room temperature for 6 hours.

The method of preparing metal nanoparticles using the phase transfer reduction method may be useful in preparing metal nanoparticles having various particle sizes according to the kind of precursors used, and a length of the alkyl chain of the amine used as the capping agent by significantly reducing a reduction reaction rate according to distribution equilibrium between an intermediate formed by a coordinate bond between various precursors and a capping material and a reducing agent present in the aqueous phase, and also in facilitating separation/purification of the metal nanoparticles from an organic layer in which most reaction by-products are present as the nanoparticle precipitate into the aqueous layer from the organic layer due to a difference in density of the metal nanoparticles formed during a reaction, and ensuring excellent processability in which a particle size of the metal nanoparticles is easily controlled as a self-quenching reaction in which no metal nanoparticles in the aqueous layer grow any more takes place when a metal intermediate serving as a reaction starting material is significantly lowered in amount.

Also, in the method of preparing metal nanoparticles according to the present invention, the average particle size of the metal nanoparticles may be controlled according to the length of the alkyl chain of the amine serving as the capping agent and the length of the alkyl chain of the metal precursor. Therefore, since the sintering temperature may be widely adjusted from a low temperature to a high temperature, for example, from 130° C. to 350° C., a metal ink having excellent electrical properties may be prepared.

For example, the amine may have a sintering temperature of 130 to 160° C. when the amine has 2 to 5 carbon atoms, a sintering temperature of 160 to 200° C. when the amine has 6 to 10 carbon atoms, a sintering temperature of 200 to 250° C. when the amine has 11 to 15 carbon atoms, and a sintering temperature of 250° C. or more when the amine has at least 16 carbon atoms.

Also, the present invention provides a metal ink including the metal nanoparticles prepared using the above-described method. The metal ink includes a solvent functioning as a dispersion medium in which the metal nanoparticles are dispersed, a dispersion stabilizer, and a binder. Also, the metal ink may further include other additives to control physical properties.

The metal nanoparticles may be properly included in the metal ink according to applications of the metal ink. Preferably, the metal nanoparticles may be included at a content of 10 to 70% by weight, based on the total weight of the metal ink.

The organic solvent may be at least one selected from the group consisting of an ether (THF, ethyl ether, propyl ether, or MEK), a benzene (xylene, toluene, ethylbenzene, or benzene), an alcohol (methanol, ethanol, butanol, propanol, ethylene glycol, or propylene glycol), a chloride (methylene chloride, or chloroform), a sulfide (DMSO), a nitride (DMF, DEF, ethylamine, ammonia, ethanol amine, diethanol amine, triethanol amine, or triethylamine), and an alkyl (hexane, pentane, or butane). Also, the dispersion stabilizer, the binder, and the other additives may be known materials used to prepare a metal ink including the metal nanoparticles.

For example, a surfactant such as polyvinylpyrrolidone (PVP), polyacrylic acid (PAA), sodium dodecyl sulfate (SDS), Tween 20 or DowFax™ may be included as the dispersion stabilizer at a content of 0.1% to 5% by weight, based on the total weight of the final ink, and a polymer resin such as a cellulose-based resin and an epoxy-based resin may be included as the binder at a content of 0.1% to 10% by weight, based on the total weight of the final ink. Also, a thickener may also be further included as the other additive at a content of 0.1% to 5% by weight, based on the total weight of the final ink, and an amine, more particularly, NH₃, NH(CH₃)₂, N(CH₃)₃, NH₂Et, NH(Et)₂ or NEt₃, may be further included as the catalyst at a content of 10 to 50%, based on the total weight of the final ink.

To improve dispersibility of the metal nanoparticles, the method according to the present invention may also further include performing supersonic agitation, eddy current agitation, mechanical agitation, or ball or roll mill treatment on the metal nanoparticles. For example, the supersonic agitation may be performed for approximately 5 minutes to 2 hours at 5 to 50 Hz, the eddy current agitation may be performed for approximately 10 minutes to 4 hours at 50 to 1,000 rpm, and the ball mill treatment may be performed by introducing balls and a solution at a weight ratio of 1:1 and stirring the solution for approximately 4 to 24 hours.

Hereinafter, the present invention will be described in further detail with reference to the following Examples. However, it should be understood that the description presented herein is not intended to limit the scope of the present invention.

### Example 1

### Synthesis of Ag precursor

1.7 g of oleic acid was put into a 250 ml flask, and dissolved in 84 ml of a polar organic solvent, THF, and 2.7 g of NEt₃ was added as a base. Thereafter, 1.4 g of AgNO₃ was put into another 250 ml flask, and dissolved in 84 ml of an organic solvent, THF. The AgNO₃ solution was slowly dropped in the oleic acid solution at a rate of 700 ml/hr while vigorously stirring. The mixed solution in which addition of the AgNO₃ solution was completed was stirred for 30 minutes, and a precipitate was separated, washed twice with an organic solvent (THF), and then dried to form approximately 2.0 g of a Ag precursor (Ag-oleate).

Synthesis of Ag Nanoparticles

0.6 g of the Ag-oleate was put into a 250 ml flask which was a first container, and dissolved in 3.6 ml of toluene. Thereafter, butylamine was put into the first container at a molar concentration 4 times that of the Ag-oleate to prepare an organic phase. Then, 3.6 ml of water was put into a 25 ml flask which was a second container, and a reducing agent, trisodium citrate, was put into the second container at a molar concentration ½ times that of the Ag-oleate to prepare an aqueous phase. Subsequently, the aqueous phase was dropped in the organic phase at a rate of 100 ml/hr, and the resulting mixed solution was stirred for 30 minutes, and precipitated for 60 minutes to obtain 0.5 g of a precipitate.

The precipitate was washed twice with an organic solvent (ethanol), and then dried to synthesize Ag nanoparticles.

### Example 2

Ag nanoparticles were synthesized in the same manner as in Example 1, except that octylamine having 8 carbon atoms was used instead of the butylamine.

### Example 3

Ag nanoparticles were synthesized in the same manner as in Example 1, except that decylamine having 10 carbon atoms was used instead of the butylamine.

### Example 4

Ag nanoparticles were synthesized in the same manner as in Example 1, except that oleylamine having 18 carbon atoms was used instead of the butylamine.

### Example 5

0.5 g of the Ag nanoparticles prepared in Example 1 were dispersed in 2.83 ml of an organic solvent (EG). As the additives, an amine (NH₃) serving as a catalyst and a dispersion stabilizer (polyvinylpyrrolidone) were added at contents of approximately 30% by weight and 0.5% by weight, respectively, based on the total weight of the metal ink, and uniformly mixed at 30 Hz for an hour by supersonic agitation to prepare a Ag ink.

### Example 6

0.5 g of the Ag nanoparticles prepared in Example 2 was dispersed in 2.83 ml of an organic solvent (EG). As the additives, an amine (NH₃) serving as a catalyst and a dispersion stabilizer (polyvinylpyrrolidone) were added at contents of approximately 30% by weight and 0.5% by weight, respectively, based on the total weight of the metal ink, and uniformly mixed at 30 Hz for an hour by supersonic agitation to prepare a Ag ink.

### Example 7

0.5 g of the Ag nanoparticles prepared in Example 3 was dispersed in 2.83 ml of an organic solvent (EG). As the additives, an amine (NH₃) serving as a catalyst and a dispersion stabilizer (polyvinylpyrrolidone) were added at contents of approximately 30% by weight and 0.5% by weight, respectively, based on the total weight of the metal ink, and uniformly mixed at 30 Hz for an hour by supersonic agitation to prepare a Ag ink.

### Example 8

0.5 g of the Ag nanoparticles prepared in Example 4 was dispersed in 2.83 ml of an organic solvent (EG). As the additives, an amine (NH₃) serving as a catalyst and a dispersion stabilizer (polyvinylpyrrolidone) were added at contents of approximately 30% by weight and 0.5% by weight, respectively, based on the total weight of the metal ink, and uniformly mixed at 30 Hz for an hour by supersonic agitation to prepare a Ag ink.

### Example 9

A Ag ink was prepared in the same manner as in Example 5, except that a ball mill process was performed for 8 hours instead of the supersonic agitation.

### Experimental Example 1

The Ag nanoparticles prepared in Examples 1 to 4 were measured under an SEM to calculate an average particle size from particle sizes of 500 nanoparticles whose particle sizes was able to be identified. The calculation results of the average particle sizes are listed in the following Table 1 and shown in FIG. 3.

The reacted Ag nanoparticles were washed twice with an alcohol, diluted, and then measured under a TEM.

TABLE 1

| | Average particle size |
|---|---|
| Ag nanoparticles of Example 1 | 70 nm |
| Ag nanoparticles of Example 2 | 35 nm |
| Ag nanoparticles of Example 3 | 25 nm |
| Ag nanoparticles of Example 4 | 10 mn |

### Experimental Example 2

Each of the Ag inks prepared in Examples 5 to 9 was coated on a substrate (glass) using a spin coating method, dried at 100° C., and then sintered at 150° C., 180° C., 220° C. and 260° C. for 20 minutes to prepare a silver thin film. Thereafter, physical properties of the prepared silver thin film were measured. The measurement results are listed in the following Table 2. After a coating film was scratched with an injection needle after a coating process, thin film thicknesses were measured at a scratched region and a coated region using a 3D surface profiler, and a surface resistivity value was measured after the coating process using a 4-point probe.

TABLE 2

| | Sintering | Thin film thickness | Surface resistivity |
|---|---|---|---|
| | temperature (° C.) | (nm) | value (Ω/□) |
| Example 5 | 150 | 384 | 0.20 |
| Example 6 | 180 | 391 | 0.22 |
| Example 7 | 220 | 403 | 0.23 |
| Example 8 | 260 | 395 | 0.21 |
| Example 9 | 150 | 370 | 0.20 |

As seen from Examples and Experimental Examples, it was confirmed that the metal nanoparticles prepared according to the method of the present invention had different particle sizes according to the kind of a capping agent (i.e., an alkyl chain length of an amine). As a result, it was confirmed that the metal nanoparticles were sintered at various sintering temperatures.

Also, it could be seen that the silver thin films including the metal nanoparticles prepared according to the method of the present invention had excellent electrical properties and exhibited good surface roughness and adhesive strength.

1. A method of preparing metal nanoparticles, comprising:
dissolving a metal precursor and a capping agent in an organic phase;
dissolving a reducing agent in an aqueous phase;
mixing the organic phase and the aqueous phase to form a precipitate;
separating the precipitate; and
drying the separated precipitate.

2. The method of claim 1, wherein the metal precursor has a structure represented by the following Formula 1: 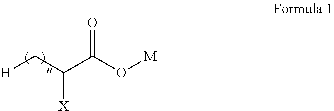
wherein X represents hydrogen, an alkyl group having 1 to 6 carbon atoms, or a halogen, M is selected from the group consisting of Ag, Pd, Rh, Cu, Pt, Ni, Fe, Ru, Os, Mn, Cr, Mo, Au, W, Co, Ir, Zn and Cd, and n is an integer ranging from 0 to 23.

3. The method of claim 1, wherein the capping agent is an alkylamine whose main alkyl chain has a length of 4 to 20.

4. The method of claim 3, wherein the capping agent is an alkylamine substituted with C, H or O at a position of each main alkyl chain.

5. The method of claim 1, wherein the reducing agent is at least one selected from the group consisting of trisodium citrate, NaBH₄, phenylhydrazine.HCl, phenylhydrazine, ascorbic acid, and hydrazine.

6. The method of claim 1, wherein the capping agent is used at a molar concentration 1 to 10 times that of the metal precursor, and the reducing agent is used at a molar concentration 2 to ¼ times that of the metal precursor.

7. The method of claim 1, wherein the mixing of the organic phase and the aqueous phase is performed by dropping the aqueous phase into the organic phase at a rate of 1 ml/sec to 1,000 ml/h.

8. The method of claim 1, wherein an average particle size of the metal nanoparticles is controlled according to a length of the main alkyl chain of the metal precursor or a substituent thereof, or a length of an alkyl chain of the capping agent.

9. A metal ink comprising the metal nanoparticles prepared using the method defined in claim 1.
